(19) United States
(12) Patent Application Publication
(10) Pub. No.: US 2026/0085719 A1
(43) Pub. Date: Mar. 26, 2026

(54) BEARING WITH SENSOR

(71) Applicant: NTN CORPORATION, Osaka (JP)

(72) Inventor: Hiroyoshi ITO, Mie (JP)

(73) Assignee: NTN CORPORATION, Osaka (JP)

(21) Appl. No.: 19/111,176

(22) PCT Filed: Sep. 7, 2023
(86) PCT No.: PCT/JP2023/032715

§ 371 Date: Mar. 12, 2025

(30) Foreign Application Priority Data
Sep. 14, 2022 (JP) 2022-146322

(51) Int. Cl. F16C 19/06; F16C 41/00

(52) U.S. Cl. CPC F16C 19/06; F16C 41/007; F16C 41/008; F16C 2233/00

(57) ABSTRACT

A sensor-equipped bearing is provided which includes a rolling bearing and a magnetic rotation sensor, and which further includes a hook member formed into an annular shape using a resin. The magnetic rotation sensor includes a magnetic ring coupled to an outer peripheral portion of an inner ring; and a magnetic sensor unit coupled to an outer ring. The magnetic ring includes a magnetic rubber member fixed to an annular metal core. The outer peripheral portion of the inner ring is formed with an outer peripheral groove circumferentially extending. The hook member includes a protrusion engaged in the outer peripheral groove of the inner ring. A metal core is held by the hook member.

### TECHNICAL FIELD

The present invention relates to a sensor-equipped bearing comprising a rolling bearing and a magnetic rotation sensor that detects a relative rotational motion between an inner ring and an outer ring of the rolling bearing.

### BACKGROUND ART

As such a sensor-equipped bearing, there is a sensor-equipped bearing in which a magnetic ring is coupled to an outer peripheral portion of an inner ring of a rolling bearing, and a magnetic sensor unit is coupled to an outer ring of the rolling bearing.

As the magnetic ring, a magnetic ring including a magnetized magnetic rubber member is used. The magnetic rubber member has N poles and S poles alternately in the circumferential direction. In order to prevent deformation of the magnetic rubber member, the magnetic rubber member is fixed to a metal core. The magnetic ring is fixed to the inner ring by press-fitting the metal core into the outer peripheral portion of the inner ring. As the inner ring and the outer ring rotate relative to each other, the magnetic ring and the magnetic sensor unit also rotate relative to each other, so that a magnetic field detected by a magnetic sensor of the magnetic sensor unit changes. The magnetic sensor unit converts the change in the magnetic field into an electric signal and outputs the electric signal (below-identified Patent Document 1).

### PRIOR ART DOCUMENT

### Patent Document

Patent Document 1: Japanese Unexamined Patent Application Publication No. 2005-256892

### SUMMARY OF THE INVENTION

### Problems to be Solved by the Invention

However, in the case of a coupling structure in which the metal core of the magnetic ring is press-fitted into the outer peripheral portion of the inner ring as in Patent Document 1, since the magnetic ring is fixed in position by friction at its fitting portion, press-fitted, the width and the radial interference of the fitting portion need to be ensured accordingly. Therefore, if the thickness of the inner ring is small and the radial thickness of the rolling bearing between the inner diameter and the outer diameter thereof (bearing cross-sectional height from the radially inner surface of the inner ring to the radially outer surface of the outer ring) is small, there is a concern that the radially inner surface of the inner ring may contract due to press-fitting of the metal core onto the outer peripheral portion of the inner ring. Also, if the width of the inner ring is small, there is a concern that the width of the fitting portion for press-fitting cannot be sufficiently ensured on the outer peripheral portion of the inner ring. In the case of a rolling bearing having these concerns, the magnetic ring cannot be fixed to the outer peripheral portion of the inner ring of the rolling bearing.

Also, since the metal core of the magnetic ring is press-fitted on the outer peripheral portion of the inner ring, it is difficult to detach the magnetic ring from the inner ring without damaging the magnetic ring. For this reason, when the rolling bearing or the inner ring needs to be replaced due to damage to the rolling bearing or the inner ring, it is not possible to realize a situation where the magnetic ring is detached from the inner ring, and the detached magnetic ring is attached to a new inner ring and reused.

In view of the above, it is an object of the present invention (i) to avoid contraction of the radially inner surface of an inner ring of a rolling bearing even when a magnetic ring of a magnetic rotation sensor is coupled to an outer peripheral portion of the inner ring, (ii) to make it possible to couple the magnetic ring to the outer peripheral portion of the inner ring even if the width of the inner ring is small, and (iii) to improve reusability of the magnetic ring when replacing the inner ring.

### Means for Solving the Problems

In order to achieve the above object, the present invention provides an arrangement 1 in which a sensor-equipped bearing comprises: a rolling bearing including an inner ring, an outer ring, and a plurality of rolling elements; and a magnetic rotation sensor for detecting a relative rotational motion between the inner ring and the outer ring, wherein the inner ring has: a raceway surface; a width surface located at one end of a width of the inner ring; and an outer peripheral portion that is continuous with the width surface and the raceway surface, wherein the magnetic rotation sensor includes: a magnetic ring coupled to the outer peripheral portion of the inner ring; and a magnetic sensor unit coupled to the outer ring, and wherein the magnetic ring includes: a metal core formed into an annular shape; and a magnetic rubber member fixed to the metal core, characterized in that the sensor-equipped bearing further comprises a hook member formed into an annular shape using a resin, wherein an outer peripheral groove is formed in the outer peripheral portion of the inner ring so as to circumferentially extend, wherein the hook member has a protrusion engaged in the outer peripheral groove of the inner ring, and wherein the magnetic ring is held by the hook member.

With the above arrangement 1, it is possible to push the protrusion of the resin hook member into the outer peripheral groove of the inner ring by using elastic deformation of the hook member such that the protrusion is engaged in the outer peripheral groove. Due to this, it is not necessary to ensure a large radial interference and a large fitting width between the hook member and the outer peripheral portion of the inner ring unlike a coupling structure that relies on press-fitting. Therefore, the hook member can be fixed to the outer peripheral portion of the inner ring while avoiding contraction of the radially inner surface of the inner ring, and the hook member can be fixed to the outer peripheral portion of the inner ring even if the width of the inner ring is small. Since the magnetic ring is held by the hook member, it is also possible to couple the magnetic ring to the outer peripheral portion of the inner ring with the hook member, and to fix the position of the magnetic ring with respect to the inner ring. Also, since the protrusion can be easily taken out of the outer peripheral groove of the inner ring by using elastic deformation of the hook member, the hook member and the magnetic ring are not damaged easily when detaching them from the inner ring. Therefore, it is possible to improve reusability of the magnetic ring when the inner ring is replaced.

In the above arrangement 1, an arrangement 2 can be used in which the hook member has a groove that circumferentially extends, and the metal core is engaged in the groove of the hook member.

With the above arrangement 2, it is possible to push the metal core into the groove of the resin hook member such that the metal core is engaged in the groove of the hook member by using elastic deformation of the hook member. Due to this, it is not necessary to set a tight interference between the groove of the hook member and the metal core. Therefore, since it is possible to easily take the metal core out of the groove by using elastic deformation of the hook member, the magnetic ring is not damaged easily when the metal core is detached from the groove. As a result, it is possible to improve reusability of the magnetic ring detached from the hook member. Therefore, even if the hook member detached from the inner ring is not suitable for reuse due to damage, deterioration, or the like, it is possible to avoid replacement of the magnetic ring.

In the above arrangement 2, an arrangement 3 can be used in which the hook member has an inner periphery including the groove of the hook member, the metal core has a first plate surface and a second plate surface axially opposed to each other, the groove of the hook member is located at a position displaced radially outward from the width surface of the inner ring, the first plate surface is axially in contact with the width surface of the inner ring, and the groove of the hook member is hooked on the second plate surface.

With the above arrangement 3, the groove is disposed on the inner periphery of the hook member so as to be located at a position displaced radially outward from the width surface of the inner ring. Therefore, of the first plate surface and the second plate surface of the metal core, which are axially opposed to each other, the first plate surface can be brought into contact with the width surface of the inner ring so that the inner peripheral side of the metal core can be axially received by the width surface, and the groove can be hooked on the second plate surface so that the outer peripheral side of the metal core can be axially received by the groove. Therefore, even if the area of the groove hooked on the second plate surface is small, the position of the metal core with respect to the hook member and the inner ring can be kept constant, and it is possible to prevent inclination of the metal core with respect to the radial direction. Therefore, it is possible to reduce the radial depth of the groove so as to reduce the area of the groove hooked on the second plate surface, and, as a result, it is possible to reduce the outer diameter of the hook member, and to easily detach and insert the metal core with respect to the groove.

In the above arrangement 3, an arrangement 4 can be used in which the magnetic rubber member is bonded to the second plate surface.

With the above arrangement 4, since the magnetic rubber member can be disposed by using the axial thickness of the portion of the groove of the hook member that is hooked on the second plate surface of the metal core, it is possible to reduce the amount by which the magnetic ring axially protrudes with respect to the width surface of the inner ring.

In the above arrangement 3 or 4, an arrangement 5 can be used in which the metal core comprises a metal plate extending along a radial direction.

With the above arrangement 5, since the metal core is a radially extending metal plate, it is possible to reduce the width and the total radial length of the mental core, while reducing the cost for machining the metal core.

In any one of the above arrangements 3 to 5, an arrangement 6 can be used in which the magnetic sensor unit includes a magnetic sensor at a position axially opposed to the magnetic rubber member.

With the above arrangement 6, the magnetic sensor and a circuit board can be disposed while avoiding a space located radially outward with respect to the magnetic rubber member. Such a disposition is suitable for disposing the magnetic rotation sensor so as not to radially protrude beyond the rolling bearing even if the radial thickness of the rolling bearing between its inner and outer diameters and is small.

### Effects of the Invention

As described above, by using the above arrangement 1, the present invention can (i) avoid contraction of the radially inner surface of the inner ring of the rolling bearing even when the magnetic ring of the magnetic rotation sensor is coupled to the outer peripheral portion of the inner ring, (ii) couple the magnetic ring to the outer peripheral portion of the inner ring even if the width of the inner ring is small, and (iii) improve reusability of the magnetic ring when replacing the inner ring.

### BRIEF DESCRIPTION OF THE DRAWINGS

FIG. 1 is a vertical sectional front view illustrating a sensor-equipped bearing according to a first embodiment of the present invention, using a sectional surface taken along line I-I in FIG. 2.

FIG. 2 is a right-side view of the sensor-equipped bearing according to the first embodiment.

FIG. 3 is a partially enlarged sectional view illustrating a sectional surface taken along line III-III in FIG. 2.

FIG. 4 is a view illustrating a jig set used in a step of attaching a magnetic ring to an inner ring according to the first embodiment.

FIG. 5 is a view illustrating, as an example, a structure for applying a preload to the sensor-equipped bearing in FIG. 1.

FIG. 6 is a view illustrating, as another example, a structure for applying a preload to the sensor-equipped bearing in FIG. 1.

FIG. 7 is a vertical sectional front view illustrating a sensor-equipped bearing according to a second embodiment of the present invention, using a sectional surface similar to FIG. 1.

FIG. 8 is a partially enlarged sectional view illustrating the sensor-equipped bearing in FIG. 7, using a sectional surface similar to FIG. 3.

FIG. 9 is a partial plan view illustrating a modification of outer protrusions of a sensor holder according to the second embodiment.

FIG. 10 is a right-side view illustrating an outer ring and a magnetic sensor unit of the sensor-equipped bearing according to the second embodiment that have been extracted

FIG. 11 is a vertical sectional front view illustrating a sensor-equipped bearing according to a third embodiment of the present invention, using a sectional surface similar to FIG. 1.

FIG. 12 is a partially enlarged sectional view illustrating the sensor-equipped bearing in FIG. 11, using a sectional surface similar to FIG. 3.

FIG. 13 is a right-side view illustrating an outer ring and a magnetic sensor unit of the sensor-equipped bearing according to the third embodiment that have been extracted

### BEST MODE FOR CARRYING OUT THE INVENTION

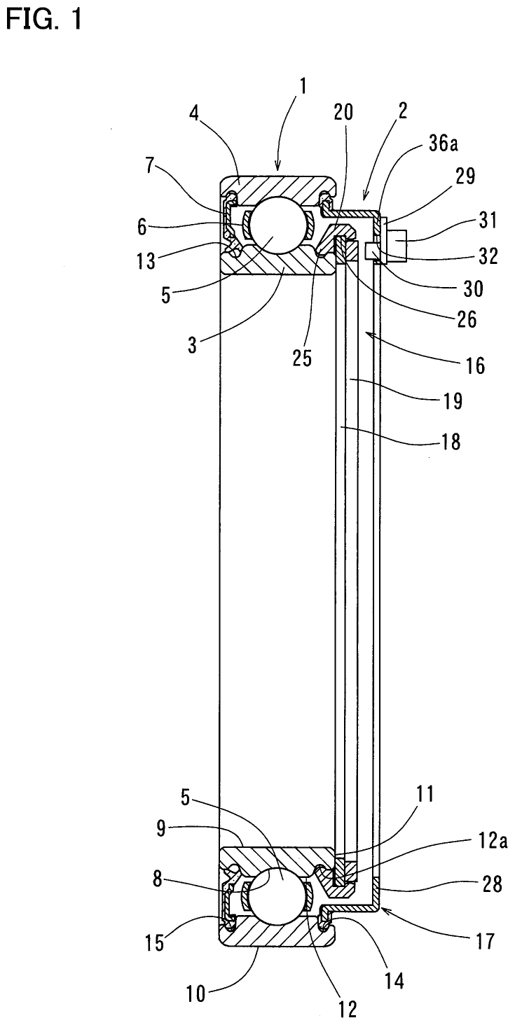

A sensor-equipped bearing according to a first embodiment as an example of the present invention will be described with reference to FIGS. 1 to 6.

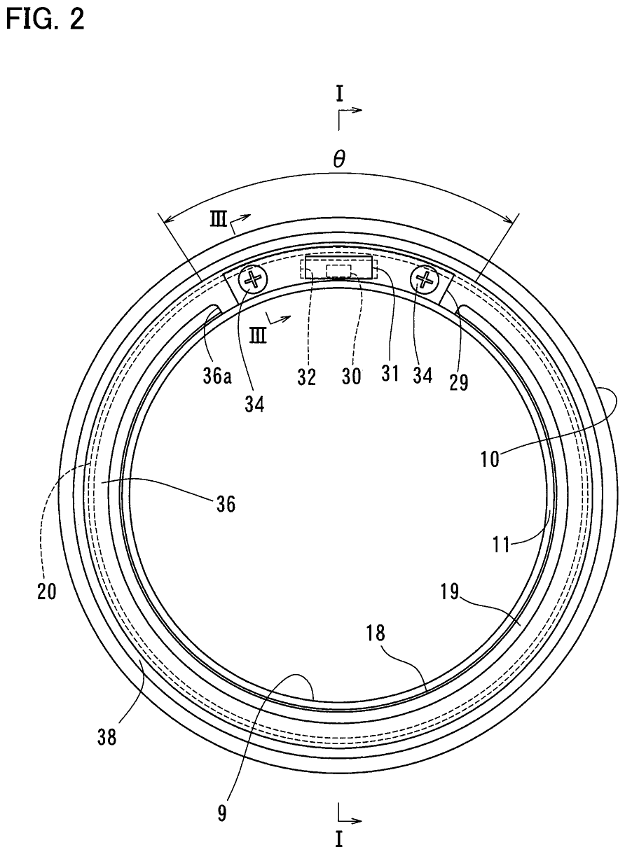

The sensor-equipped bearing illustrated in FIGS. 1 and 2 comprises a rolling bearing 1 and a magnetic rotation sensor 2.

The rolling bearing 1 includes an inner ring 3, an outer ring 4, a plurality of rolling elements 5, a cage 6 that retains the rolling elements 5, and a seal 7 attached to the outer ring 4.

The inner ring 3 has an outer periphery including an outer peripheral raceway surface 8, and a radially inner surface 9 defining the inner diameter of the rolling bearing 1, and the inner ring 3 comprises a single seamless bearing ring. The outer ring 4 comprises a single bearing ring having a shape that corresponds to the inner ring 3, and has a radially outer surface 10 that defines the outer diameter of the rolling bearing 1. The inner ring 3 and the outer ring 4 are each formed of a metal such as a bearing steel.

As used herein, the terms “axial” and “axially” refer to the direction along the rotation center axis of the rolling bearing 1; the terms “radial” and “radially” refer to a direction orthogonal to the rotation center axis; and the terms “circumferential” and “circumferentially” refer to the direction around the rotation center axis as a rotation center line. The axial direction corresponds to the left-right direction in FIG. 1, the radial direction corresponds to the vertical direction in FIG. 1, and each of the center axes of the inner ring 3 and the outer ring 4 coincides with the rotation center axis of the rolling bearing 1.

The rolling elements 5 are disposed between the inner ring 3 and the outer ring 4. The cage 6 retains/keeps the circumferential intervals between the respective adjacent pair of rolling elements 5. The inner ring 3 is used as a rotating ring. The outer ring 4 is used as a stationary ring. Due to relative rotation between the inner ring 3 and the outer ring 4, the rolling elements 5 roll on the raceway surface 8 as the inner ring 3 rotates.

While a ball bearing is exemplified as the rolling bearing 1, a roller bearing may be used as the rolling bearing 1 instead. Also, while an inseparable bearing such as a deep groove ball bearing is exemplified as the rolling bearing 1, a separable bearing such as a tapered roller bearing may be used as the rolling bearing 1 instead.

While the cage 6 is exemplified as comprising a thin metal plate formed by pressing, the material of the cage 6 and the method of manufacturing the cage 6 are not limited thereto, and the cage 6 may be an iron plate cage or a resin cage formed by injection molding of a resin. As the resin, for example, it is possible to use a thermoplastic resin such as polyamide (PA) reinforced with glass fiber. If a resin cage/retainer is used as the cage 6, the resin cage may be a so-called crown-shaped cage or the resin retainer may be a cage.

The inner ring 3 has an outer periphery including the raceway surface 8, and a radially inner surface 9 defining the inner diameter of the rolling bearing 1.

The inner ring 3 has a width surface 11 located at one end (right side in FIG. 1) of the width of the inner ring 3; and an outer peripheral portion 12 continuous with the raceway surface 8 and the width surface 11. The width of the inner ring 3 refers to the entire axial length of the inner ring 3. The width surface 11 is a circular annular surface along the radial direction. The outer peripheral portion 12 of the inner ring 3 has an outer peripheral groove 12a extending in the circumferential direction. The outer peripheral groove 12a has a groove width smaller than the width of the outer peripheral portion 12, and continuously extends around the entire circumference. The outer peripheral portion 12 of the inner ring 3 has a shoulder portion 12b located between, and continuous with, the outer peripheral groove 12a and the width surface 11, and the shoulder portion 12 comprise a cylindrical surface-shaped portion that is continuous with the outer peripheral groove 12a, and that defines the outer diameter of the shoulder portion 12b; and a chamfer continuously extending from the cylindrical surface-shaped portion to the width surface 11. The inner ring 3 has a seal groove 13 formed in the outer periphery of the other end (left side in FIG. 1) thereof, and continuously extending around the entire circumference.

An inner peripheral groove 14 is formed in one end (right end in FIG. 1) of the inner periphery of the outer ring 4, and a seal groove 15 is formed in the other end (left end in FIG. 1) thereof. The inner peripheral groove 14 and the seal groove 15 continuously extend around the entire circumference.

Each of the inner ring 3 and the outer ring 4 is a ring for a standard sealed bearing, and is formed symmetrically with respect to an imaginary plane extending along the radial direction so as to bisect the width of the inner ring 3 or the outer ring 4.

The seal 7 is attached to the other axial end (left side in FIG. 1) in an annular bearing interior space defined between the inner ring 3 and the outer ring 4. The seal 7 is engaged in the seal groove 15 of the outer ring 4 (stationary ring). The seal 7 and the seal groove 13 of the inner ring 3 cooperate with each other to prevent grease leakage from the bearing interior space and to prevent foreign matter from entering the bearing interior space. The seal 7 comprises a metal core constituted by a thin plate formed by pressing; and an oil-resistant rubber member vulcanization-bonded to the metal core, the oil-resistant rubber member including a lip that slides on the seal groove 13; and an outer peripheral portion engaged in the seal groove 15. Examples of the oil-resistant rubber (member) include, e.g., nitrile rubber (NBR), hydrogenated nitrile rubber (HNBR), fluororubber (FKM), and acrylic rubber (ACM). The material and the manufacturing method of the seal 7 are not particularly limited, and, for example, the seal 7 may be a seal comprising a thin metal plate which is formed by pressing, and on which an anti-rust film such as tin plating or zinc plating is formed, or may be a seal comprising a plated steel plate which is formed by pressing, and which is subjected to a surface treatment beforehand. Also, a contact seal is exemplified as the seal 7, but a non-contact seal may be used as the seal 7.

The magnetic rotation sensor 2 detects a relative rotational motion between the inner ring 3 and the outer ring 4. The magnetic rotation sensor 2 includes a magnetic ring 16 coupled to the outer peripheral portion 12 of the inner ring 3, and a magnetic sensor unit 17 coupled to the outer ring 4.

The magnetic ring 16 comprises a metal core 18 formed into an annular shape, and a magnetic rubber member 19 fixed to the metal core 18. The magnetic ring 16 is coupled to the outer peripheral portion 12 of the inner ring 3 by a hook member 20.

The metal core 18 comprises a single seamless metal plate. The metal core 18 is formed by pressing a single thin plate. Examples of the metal plate include, e.g., a soft steel plate and a stainless steel plate. Examples of the soft steel plate include, e.g., SPCC, SPCCT, SPCD, SPCE, and SPCEN that are specified in Japanese Industrial Standards. Examples of the stainless steel plate include, e.g., SUS430, SUS201, SUS304, SUS316, SUS321, SUS403, and SUS410 that are specified in Japanese Industrial Standards. If the metal core 18 is cut, it is also possible to use a carbon steel for machine structural use such as S45C specified in Japanese Industrial Standards. Also, using a magnetic substance for the metal core 18 is advantageous in that the magnetic properties improve.

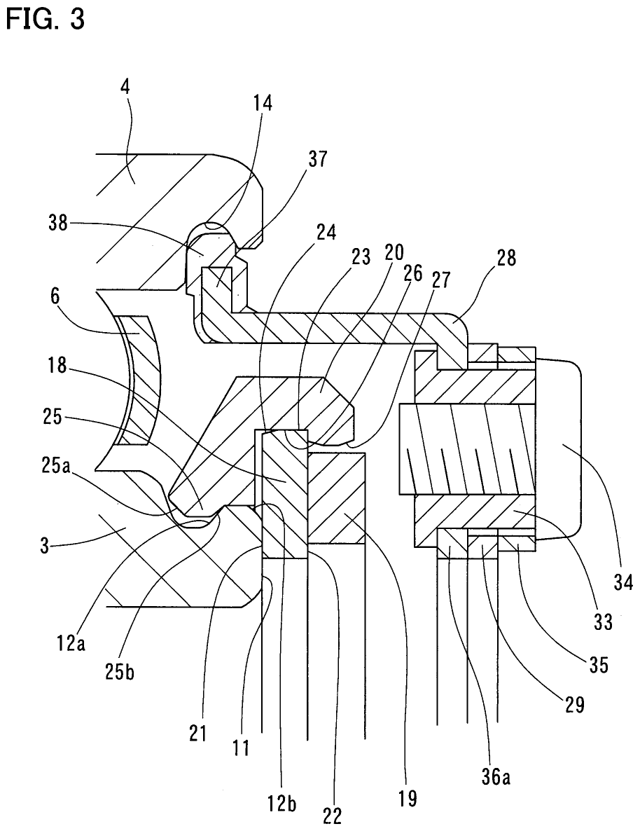

The metal core 18 has an inner periphery and an outer periphery having a common center axis, and has a circular annular shape along the radial direction. As illustrated in FIG. 3, the metal core 18 has a first plate surface 21 and a second plate surface 22 that are opposed to each other in the axial direction. Each of the first plate surface 21 and the second plate surface 22 comprises a flat surface extending along the radial direction and continuously extending around the entire circumference. The metal core 18 has an radially outer surface 23 formed into a cylindrical surface shape. In the metal core 18, a corner is defined by the second plate surface 22 and the peripheral edge of the radially outer surface 23 at one end thereof (right side in FIG. 3). The first plate surface 21 has an outer diameter smaller than the diameter of the radially outer surface 23. Of the outer periphery of the metal core 18, the portion between the first plate surface 21 and the peripheral edge of the radially outer surface 23 at the other end thereof (left side in FIG. 3) is a tapered surface 24 inclined such that the diameter of the tapered surface 24 gradually decreases toward the other end (left side in FIG. 3) from the radially outer surface 23. The inner periphery of the metal core 18 has a cylindrical surface shape.

While, in order to reduce the overall axial length of the metal core 18, a metal plate extending along the radial direction is used as the metal core 18, the metal core 18 is not limited thereto, and, for example, for the purpose of, e.g., positioning the magnetic rubber member 19 or reinforcing the metal core, a flange may be formed by pressing such as drawing so as to axially extend from the second plate surface 22 to the side on which one end is located.

The magnetic rubber member 19 is an annular member made of a magnetic rubber material. The magnetic rubber material comprises a rubber and a magnetic powder mixed with the rubber. Examples of the rubber include, e.g., NBR, HNBR, FKM, and ACM. Examples of the magnetic powder include, e.g., ferrite-based powder, neodymium-based (Nd-based) powder, and samarium-based (Sm-based) powder.

The magnetic rubber member 19 is fixed to the second plate surface 22 of the metal core 18 by bonding. The magnetic rubber member 19 has an inner periphery and an outer periphery that are concentric with the metal core 18, and has a circular annular shape along the radial direction. The magnetic rubber member 19 has an outer diameter sufficiently smaller than the outer diameter of the metal core 18 in order to avoid interference between the magnetic rubber member 19 and the hook member 20.

The magnetic rubber member 19 may be bonded to the metal core 18 by vulcanization. If the rubber member is bonded by vulcanization, an adhesive is applied to the second plate surface 22 of the metal core 18 in advance.

The magnetic rubber member 19 is multipole-magnetized so as to have N poles and S poles alternately in the circumferential direction. The number of magnetized rows (tracks) during multipole-magnetization is not particularly limited, but at least one magnetized row is required.

While not shown, the steps of magnetizing the magnetic rubber member 19 include, e.g.,
fixing a magnetic rubber to the second plate surface of the metal core, thereby constituting a to-be-magnetized ring;
mounting the to-be-magnetized ring on a rotary chuck (including an attaching jig) of a magnetization device; and
circumferentially rotating the to-be-magnetized ring at a constant rotation speed, thereby multipole-magnetizing the ring so as to have N poles and S poles alternately in the circumferential direction. The magnetization device includes a magnetization coil wound around a magnetization yoke, and the magnetization coil is disposed such that a desired gap is defined between the magnetization coil and the outer peripheral surface or a width surface (flat surface) of the to-be-magnetized ring. Also, in synchronization with the rotation of the to-be-magnetized ring, the direction of an electric current flowing through the magnetization coil is alternately switched, so that the ring is magnetized to have multiple poles. The number of magnetic poles is appropriately determined.

Another magnetization method may be used. Specifically, for example, a magnetization device may be used which includes a magnetization yoke disposed such that a desired gap is defined between the magnetization yoke and the outer peripheral surface or a width surface (flat surface) of a to-be-magnetized ring fixed in position so as to be non-rotatable, the magnetization yoke having protrusions corresponding in number to magnetic poles, and being provided with a magnetization coil wound around the magnetization yoke. If such a magnetization device is used, it is possible to make an electric current flow through the magnetization coil in only one direction, and to complete magnetization in a short time. This magnetization method is preferably used for magnetization of an Nd-based material, an Sm-based material, and the like.

The hook member 20 is formed into an annular shape using a resin. The hook member 20 is a single seamless resin member having an inner periphery and an outer periphery that are concentric with the inner ring 3.

The hook member 20 includes, on its inner periphery, a protrusion 25 engaged in the outer peripheral groove 12a of the inner ring 3; and a groove 26 extending in the circumferential direction.

The protrusion 25 is a portion of the hook member 20 having a diameter smaller than the outer diameter of the shoulder portion 12b of the inner ring 3. The protrusion 25 continuously extends around the entire circumference of the hook member 20. The protrusion 25 has, at the other end thereof (on the left side in the relevant figure), a first inclined surface 25a inclined such that the diameter of the first inclined surface 25a gradually increases toward the other side (left side in the relevant figure) from the inner diameter of the protrusion 25 (from an inner peripheral portion that defines the inner diameter of the protrusion 25). The protrusion 25 has, at one end thereof (on the right side in the relevant figure), a second inclined surface 25b inclined such that the diameter of the second inclined surface 25b gradually increases toward one side (right side in the relevant figure) from the inner diameter of the protrusion 25. The protrusion 25 is axially hooked on the outer peripheral groove 12a by the second inclined surface 25b. There is a space between (i) the inner ring 3 and(ii) the portion of the hook member 20 located on the inner diameter of the protrusion 25 and the portion of the hook member 20 located on the other side (left side in the relevant figure) with respect to the above inner diameter. The space and the first and second inclined surfaces 25a and 25b are disposed for easily elastically deforming the hook member 20 when the protrusion 25 is removed from, and placed into, the outer peripheral groove 12a over the shoulder portion 12b from the one side (right side in the relevant figure) with respect to the inner ring 3.

The groove 26 continuously extends around the entire circumference at a position displaced radially outward from the width surface of the inner ring. The metal core 18 is engaged in the groove 26. The groove 26 radially receives the radially outer surface 23 of the metal core 18, and is axially hooked on the second plate surface 22. Of the groove 26, the groove bottom surface radially receiving the radially outer surface 23 has a cylindrical surface shape. Of the groove 26, the portion axially hooked on the second plate surface 22 extends along the radial direction. The width of the groove 26 is larger than the width of the metal core 18.

The hook member 20 is radially in contact with the outer diameter of the shoulder portion 12b of the inner ring 3, at its inner peripheral portion connecting the groove 26 and the protrusion 25 to each other. Of the inner periphery of the hook member 20, an inner shoulder portion 27 constituting one end (right end in the relevant figure) has a convex curved surface formed such that the inner shoulder portion 27 protrudes radially most inward at the middle portion of the width of the inner shoulder portion 27.

The first plate surface 21 of the metal core 18 is axially in contact with the width surface 11 of the inner ring 3, but is not axially in contact with the hook member 20. There is a space between the first plate surface 21 and the hook member 20. This space, the curved surface of the inner shoulder portion 27, and the tapered surface 24 of the metal core 18 are disposed for easily elastically deforming the hook member 20 and the metal core 18 when the metal core 18 is removed from, and placed into, the groove 26 over the inner shoulder portion 27 from the one side (right side in the relevant figure) with respect to the hook member 20.

Since the hook member 20 is axially hooked on the outer peripheral groove 12a of the inner ring 3 and the second plate surface 22 of the metal core 18, three members, i.e., the inner ring 3, the hook member 20, and the metal core 18 are restricted so as not to be separated from each other in the axial direction. The inner ring 3 and the hook member 20 are disposed to have a common center axis by fitting of the inner periphery of the hook member 20 to the outer peripheral groove 12a and the shoulder portion 12b of the inner ring 3. The hook member 20 and the metal core 18 are disposed to have a common center axis by fitting of the radially outer surface 23 of the metal core 18 in the groove 26 of the hook member 20. The three members (20, 3, and 19) are prevented from rotating relative to each other by the friction acting on the contact portion between the outer periphery of the inner ring 3 and the inner periphery of the hook member 20, the contact portion between the width surface 11 of the inner ring 3 and the first plate surface 21 of the metal core 18, the contact portion between the hook member 20 and the second plate surface 22 of the metal core 18, and the contact portion between the hook member 20 and the radially outer surface 23 of the metal core 18. Due to restriction of the axial displacement of the three members (20, 3, 19), the coaxial arrangements of the three members (20, 3, 19), and the anti-rotation of the three members (20, 3, 19), as illustrated in FIGS. 1 and 2, the hook member 20 is fixed to the outer peripheral portion 12 of the inner ring 3, and the position of the magnetic ring 16 with respect to the inner ring 3 is also fixed, so that the magnetic ring 16 is coupled to the outer peripheral portion 12 of the inner ring 3. Therefore, the radial interference at the contact portion between the inner periphery of the hook member 20 and the outer peripheral portion 12 of the inner ring 3 is not set to a size that generates a force contracting the radially inner surface 9 of the inner ring 3.

As the resin forming the hook member 20, for example, an injection-moldable thermoplastic resin can be used. In view of detachability of the metal core 18 with respect to the groove 26, as a material for the portion of the groove 26 hooked on the second plate surface 22 of the metal core 18, it is also possible to appropriately use a resin that has an elastically deformable property, including, e.g., a polyacetal resin that does not contain a filler.

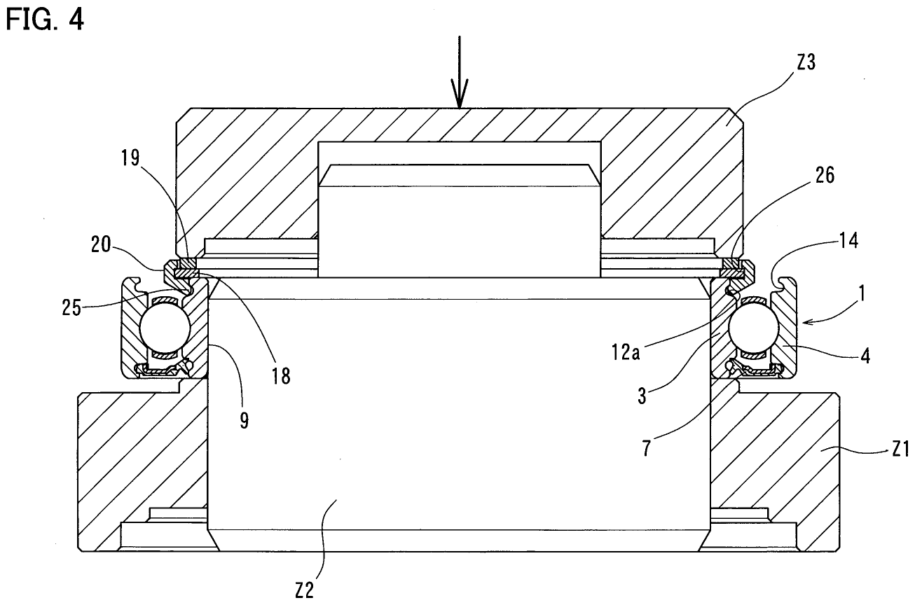

In assembly steps of coupling the magnetic ring 16 to the inner ring 3, the magnetic ring 16 can be easily coupled to the inner ring 3, for example, by using jigs Z1 to Z3 as illustrated in FIG. 4.

In the first step, a large-diameter shaft portion of a stepped shaft-shaped jig Z2 is fitted onto the radially inner surface of a jig Z1 placed on a workbench. The gap between the fitting portions of the jigs Z1 and Z2 is desirably small.

Next, in the second step, the radially inner surface 9 of the inner ring 3 of the rolling bearing 1 is fitted onto the large-diameter shaft portion of the jig Z2 from the side on which the seal 7 is located, and the inner ring 3 is brought into abutment with the upper surface of the jig Z1. The gap between the fitting portions of the large-diameter shaft portion of the jig Z2 and the radially inner surface 9 of the inner ring 3 is desirably small.

Next, in the third step, with the protrusion 25 of the hook member 20 facing downward, the hook member 20 is moved such that a small-diameter shaft portion of the jig Z2 is inserted through the hook member 20, and the first inclined surface 25a (see FIG. 3) of the protrusion 25 is disposed to vertically come into contact with the chamfer of the shoulder portion 12b (see FIG. 3) of the inner ring 3. Due to the contact between the first inclined surface 25a of the protrusion 25 and the shoulder portion 12b of the inner ring 3, the hook member 20 is guided to a position where the hook member 20 is substantially concentric with the inner ring 3.

Next, in the fourth step, the protrusion 25 of the hook member 20 is pushed into the outer peripheral groove 12a from the upper side of the inner ring 3 until the hook member 20 engages in the outer peripheral groove 12a. In the fourth step, a jig Z3 is used that has a radially inner surface that corresponds to the small-diameter shaft portion of the jig Z2 illustrated in FIG. 4. By pushing down the portion of the hook member 20 right above the protrusion 25 (upper end vertically opposed to the protrusion 25) by the lower end of the jig Z3 while fitting the jig Z3 onto the small-diameter shaft portion of the jig Z2, a component force radially expanding the hook member 20 is generated at the contact potion between the first inclined surface 25a of the hook member 20 and the shoulder portion 12b of the inner ring 3. This facilitates elastic deformation of the hook member 20 that is required for the hook member 20 to climb over the shoulder portion 12b and move down. The gap between the fitting portions of the small-diameter shaft portion of the jig Z2 and the jig Z3 is desirably small.

Next, in the fifth step, with the magnetic rubber member 19 of the magnetic ring 16 facing upward, the metal core 18 is moved such that the small-diameter shaft portion of the jig Z2 is inserted through the metal core 18, the tapered surface 24 (see FIG. 3) is disposed to vertically come into contact with the inner shoulder portion 27 (see FIG. 3) of the hook member 20. Due to the contact between the tapered surface 24 of the metal core 18 and the inner shoulder portion 27 of the hook member 20, the members (18 and 20) are guided to a position where the members (18, 20) are substantially concentric with each other.

Next, in the sixth step, while pushing down the upper surface of the magnetic rubber member 19 from above, the outer periphery of the metal core 18 is pushed into the groove 26 of the hook member 20 until the metal core 18 engages in the groove 26 as illustrated in FIG. 4. Due to this engagement, the metal core 18 is held in the groove 26 of the hook member 20. In the sixth step, by pushing down the upper surface of the magnetic rubber member 19 by the lower end of the jig Z3 while fitting the jig Z3 onto the small-diameter shaft portion of the jig Z2, a component force radially expanding the hook member 20 is generated at the contact potion between the tapered surface 24 of the metal core 18 and the inner shoulder portion 27 of the hook member 20. This facilitates elastic deformation of the hook member 20 that is required for the outer periphery of the metal core 18 to climb over the inner diameter of the inner shoulder portion 27 and move down.

If the rolling bearing 1 is a bearing where grease is sealed in the bearing interior space between the inner ring 3 and the outer ring 4, the step of sealing the grease is performed before the hook member 20 is fixed to the inner ring 3.

The magnetic sensor unit 17 illustrated in FIG. 1 includes a sensor holder 28 coupled to the outer ring 4; and a circuit board 29 attached to the sensor holder 28. A magnetic sensor 30, a connector 31, and the like are attached to the circuit board 29.

The sensor holder 28 is coupled to the inner periphery of the outer ring 4 by being engaged in the inner peripheral groove 14 of the outer ring 4. Therefore, the radial interference at the contact portion between the sensor holder 28 and the inner peripheral groove 14 is not set to a size that generates a force expanding the radially outer surface 10 of the outer ring 4.

The magnetic sensor 30 comprises an element that converts the magnetic field of the magnetic rubber member 19 into an electric signal. In the magnetic sensor 30, a magnetism sensing portion that converts a magnetic field into an analog electric signal is disposed at a position axially opposed to the magnetic rubber member 19. The magnetic sensor 30 is surface-mounted on the board surface of the circuit board 29 on the other end thereof (left side in the relevant figure). An electric circuit on the side of the sensor necessary for the magnetic sensor 30 to input and output from and to the outside is formed on the circuit board 29. The connector 31 is an input and output end of the electric circuit on the side of the sensor, and is connected to an electric circuit on the external side. The connector 31 has a shape that enables a cable (not shown) to be plugged and unplugged in the radial direction.

Various electronic components (not shown) such as a nonvolatile memory and a protection circuit are also surface-mounted on the circuit board 29. Such various electronic components are mounted for the purpose of attenuating or blocking harmful electrical noises from the outside. Examples of such various electronic components include, e.g., a common mode filter, a single mode filter, a resistor, a ceramic capacitor, a coil, a varistor, an inductor, a ceramic filter, an EMI filter, and a ferrite bead.

The number of magnetic sensors 30 disposed using the sensor holder 28 may be one or more. If a plurality of magnetic sensors are used, the magnetic sensors may be attached to a single circuit board 29, or may be separately attached to two or more circuit boards. Also, the sensor holder 28 may be used for disposing a sensor other than the magnetic sensor 30, for example, a temperature sensor, or a vibration sensor. The temperature sensor or the like may be mounted on the circuit board 29, or may be mounted on a circuit board other than the circuit board 29 and coupled to the sensor holder.

It is desirable to use lead-free solder for soldering the magnetic sensor 30 and the like. It is desirable that the magnetic sensor 30, a ceramic capacitor, and a nonvolatile memory are surface-mounted on a common surface of the circuit board 29, and that other electronic components, for example, a protection circuit component and the connector 31 are surface-mounted on the surface of the circuit board 29 opposite from the above common surface. Especially by mounting a ceramic capacitor at a position close to a power supply terminal and a GND terminal of the magnetic sensor 30, it is possible to effectively allow an external electrical noise (change in voltage) component superimposed on a power supply to flow to the GND.

Furthermore, it is desirable to use a glass-containing epoxy resin with respect to the circuit board 29. If a material is selected that has a compressive strength of 340 to 500 MPa and a flexural strength of 390 to 550 MPa, the rigidity is increased, and thus rotation detection accuracy is improved. Also, by using a multilayer board as the circuit board 29, it is possible to further reduce the dimensions of the circuit board 29.

In order to prevent migration, the circuit board 29, the magnetic sensor 30, and various electronic components as described above may be covered with a sheet-shaped thermosetting resin, or may be coated with a resin-based moisture-proof film.

If a magnetic sensor in which data can be written is used as the magnetic sensor 30, a through-hole (not shown) extending through the circuit board 29 is disposed at a portion of the surface of the circuit board 29 on which the connector 31 is mounted, a connection terminal such as a pin header (not shown) is inserted at the time of writing work so that date can be written, and then the connection terminal is removed.

As illustrated in FIG. 1, a sensor window 32 is formed in the sensor holder 28 at a position axially opposed to the magnetic rubber member 19 of magnetic ring 16. The sensor window 32 is a space for disposing the magnetic sensor 30 at a position axially opposed to a magnetic pole surface of the magnetic rubber member 19.

As illustrated in FIGS. 2 and 3, a sleeved nut 33 integrally formed with a sleeve is inserted through a round through-hole of the sensor holder 28 from the side (left side in FIG. 3) on which the other end is located, a round through-hole of the circuit board 29 and a round hole of a washer 35 are disposed on the side (right side in FIG. 3) on which one end of the sensor holder 28 is located, and a screw member 34 is screwed, relative to the washer 35, into the sleeved nut 33 from the side (right side in FIG. 3) on which the one end is located, so that the circuit board 29 and the sensor holder 28 are fastened together. Such a fastening portion is disposed at each of two locations on both circumferential sides of the circuit board 29.

The sensor holder 28 comprises an outer ring member 36 comprising a metal plate formed into a tubular shape; and a rubber part 38 fixed to an outer flange portion 37 of the outer ring member 36. The outer ring member 36 includes an inner flange portion 36a protruding radially inward at one end (right end in FIG. 3) of the outer ring member 36. The inner flange portion 36a is formed around the entire circumference. The sensor window 32 axially extends through the inner flange portion 36a. The portion of the inner flange portion 36a that includes the sensor window 32, and that is within the range of a circumferential angle θ protrudes further toward the radially inner side than the circumferential portion that is not within the angle θ. The circuit board 29 is fastened within the range of the angle θ. The angle θ is, for example, 65°. The outer flange portion 37 protrudes radially outward at the other end (left end in FIG. 3) of the outer ring member 36. Such an outer ring member 36 can be manufactured by pressing a thin plate such as a soft steel plate or a stainless steel plate. For example, such an outer ring member 36 can be manufactured by drawing a disk-shaped blank plate into a substantially cup shape to form a cup body having the outer flange portion 37, and punching the cup bottom to form the inner flange portion. The outer flange portion 37 does not need to continuously extend around the entire circumference, and while not shown, outer flange portions circumferentially separated from each other may be disposed instead such that a slit (space) is defined between each circumferentially adjacent pair of the outer flange portions.

The rubber part 38 is bonded to the sensor holder 28 so as to cover the outer periphery and both end portions of the outer flange portion 37. The rubber part 38 may be, e.g., a rubber part made of an oil-resistant rubber such as NBR, HNBR, FKM, or ACM, and bonded to the outer ring member 36 by vulcanization.

The assembly step of coupling the sensor holder 28 to the outer ring 4 is performed after the magnetic ring 16 is attached to the inner ring 3. Also, this assembly step is performed with the circuit board 29 attached to the inner flange portion 36a of the sensor holder 28. In this assembly step, the sensor holder 28 is disposed at one end (on the right side in FIG. 3) of the outer ring 4, and the rubber part 38 is pushed into the inner peripheral groove 14 while being contracted and deformed, using the elasticity of the rubber part 38. After pushing this, the rubber part 38 is fitted to the inner peripheral groove 14 by the restoring force of the rubber part 38, so that the sensor holder 28 is engaged in the inner peripheral groove 14. This engagement restricts axal, radial and circumferential displacements of the sensor holder 28 with respect to the outer ring 4, and thus the sensor holder 28 is fixed to the inner periphery of the outer ring 4.

There may be a case where the inner ring 3 has to be replaced with a new one even when there is no problem with the magnetic rotation sensor 2 of the sensor-equipped bearing illustrated in FIG. 1. In the case of the sensor-equipped bearing illustrated in FIG. 1, since the rolling bearing 1 is an inseparable bearing, when at least one of the inner ring 3, the outer ring 4, the rolling elements 5, and the cage 6 is damaged and is continuously unusable, the entire rolling bearing 1 including the inner ring 3 needs to be replaced with a new one. At that time, in order to reuse the magnetic rotation sensor 2, the following measures can be taken.

In order to reuse the magnetic sensor unit 17, first, the magnetic sensor unit 17 is detached from the outer ring 4. For example, by hooking an appropriate bearing puller (not shown) onto the inner flange portion 36a (see FIGS. 1 and 3) of the sensor holder 28; and circumferentially uniformly pulling, with the bearing puller, the sensor holder 28 toward the side on which the one end is located (toward the right side in the relevant drawings), the rubber part 38 of the sensor holder 28 is elastically compressed, and the sensor holder 28 can be easily taken out from the inner peripheral groove 14 of the outer ring 4. If the sensor holder 28 detached is not damaged, the magnetic sensor unit 17 detached can be reused by coupling the sensor unit 17 to the outer ring 4 of a new rolling bearing 1.

Even if, when detaching the sensor holder 28 from the outer ring 4, the sensor holder 28 is damaged to such an extent that it is not suitable for reuse, it is possible to reuse a circuit unit including the circuit board 29 and the magnetic sensor 30 by (i) removing all the screw members 34 by which the sensor holder 28 damaged and the circuit board 29 are fastened together; (ii) detaching the circuit unit from the sensor holder 28 damaged; (iii) attaching the circuit unit detached to a new sensor holder 28; and (iv) coupling this to the outer ring 4 of a new rolling bearing 1.

Also, in order to reuse the magnetic sensor unit 17, first, the hook member 20 holding the magnetic ring 16 is detached from the inner ring 3. With respect to this detachment, for example, by hooking an appropriate bearing puller (not shown) onto the other end portion (left end portion in FIGS. 1 and 3) of the hook member 20; and circumferentially uniformly pulling, with the bearing puller, the hook member 20 toward the side on which the one end is located (toward the right side in FIGS. 1 and 3) a component force radially expanding the hook member 20 is generated at the contact portion between the second inclined surface 25b of the protrusion 25 of the hook member 20 and the outer peripheral groove 12a of the inner ring 3. Due to this, the resin hook member 20 can be easily elastically deformed, and the protrusion 25 can be easily taken out of the outer peripheral groove 12a. If the hook member 20 detached is not damaged, the hook member 20 detached and the magnetic ring 16 held by the hook member 20 can be reused by coupling them to the inner ring 3 of a new rolling bearing 1.

Even if, when detaching the hook member 20 from the inner ring 3, the hook member 20 is damaged to such an extent that it is not suitable for reuse, the magnetic ring 16 can be reused by (i) taking the metal core 18 out of the groove 26 of the hook member 20 damaged; (ii) detaching the magnetic ring 16 from the hook member 20 damaged; (iii) attaching the magnetic ring 16 detached to a new hook member 20; and (iv) coupling this to the inner ring 3 of a new rolling bearing 1. When the hook member 20 is detached from the inner ring 3, since the width surface 11 of the inner ring 3 and the first plate surface 21 of the metal core 18 come out of contact with each other, the metal core 18 held in the groove 26 of the hook member 20 detached can be moved toward the other end of the groove 26 (toward the left side in the relevant drawing) such that a gap is defined between the second plate surface 22 of the metal core 18 and the groove 26. Also, since the groove 26 of the resin hook member 20 has a small radial depth, and thus is slightly hooked on the second plate surface 22 of the metal core 18 (since the difference in diameter between the inner diameter of the inner shoulder portion 27 and the radially outer surface 23 of the metal core 18 is small), by inserting a removal tool such as a flathead screwdriver into the gap between the inner shoulder portion 27 and the outer periphery of the magnetic rubber member 19; and pushing the inner shoulder portion 27 radially outward with the removal tool, the hook member 20 can be elastically deformed such that the inner shoulder portion 27 can climb over the radially outer surface 23 of the metal core 18 toward the other end (left side in the relevant drawing), and the metal core 18 can be easily taken out of the groove 26.

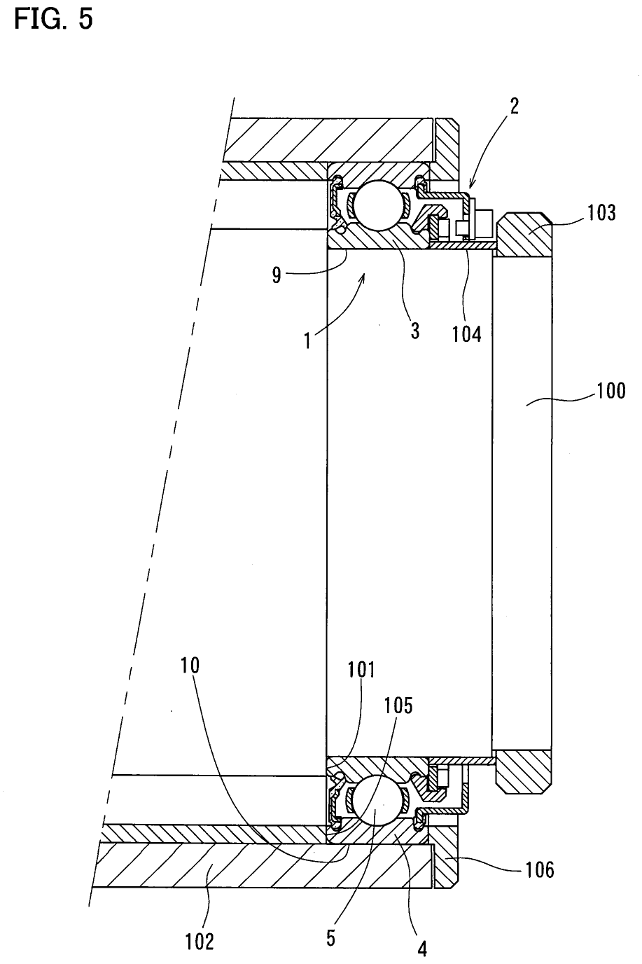

An example of use of the sensor-equipped bearing of this embodiment is illustrated in FIG. 5. FIG. 5 exemplifies a partial cross-section of an electric motor (such as an induction motor/a synchronous motor or a DC motor) having a general structure.

The radially inner surface 9 of the inner ring 3 is fitted on a small-diameter shaft portion of a stepped rotary shaft 100 having a shaft shape. The width surface of the inner ring 3 on the side on which the other end is located (on the left side in FIG. 5) is in abutment with a shaft shoulder portion 101. The radially outer surface 10 of the outer ring 4 is fitted to a housing 102. A nut 103 is screwed onto one end (right end in FIG. 5) of the rotary shaft 100. An annular spacer 104 is axially sandwiched between the nut 103 and the inner ring 3. The inner ring 3 is mounted to the rotary shaft 100 by screwing the nut 103. The width surface of the outer ring 4 on the side on which the other end is located (on the left side in FIG. 5) is in abutment with a spacer 105. A lid 106 is axially fastened to one end (right end in FIG. 5) of the housing 102. The outer ring 4 is axially fixed in position by being pushed toward the side on which the other end is located (toward the left side in FIG. 5) by the lid 106. At this time, a force is transmitted from the width surface of the outer ring 4 on the side on which the one end is located (on the right side in FIG. 5) to the width surface of the inner ring 3 on the side on which the other end is located (on the left side in FIG. 5) through the rolling elements 5, so that a preload is applied to the rolling bearing 1. As a result, the gaps between the inner ring 3, the rolling elements 5, and the outer ring 4 of the rolling bearing 1 are appropriately maintained. In this case, the width dimension of the spacer 105 is appropriately managed. This increases the rigidity of the rolling bearing 1, and improves high-speed rotation, rotation accuracy, positioning accuracy, and the like.

When the rotary shaft 100 rotates with respect to the housing 102, the inner ring 3 rotating in unison with the rotary shaft 100 rotates with respect to the outer ring 4. At this time, in the magnetic rotation sensor 2 (see FIGS. 1 and 5), since the magnetic rubber member 19 of the magnetic ring 16 rotates relative to the magnetic sensor 30 in accordance with the relative rotation of the inner ring 3 and the outer ring 4, this changes the magnetic field of the magnetic rubber member 19 detected by the magnetic sensor 30. The magnetic sensor 30 converts the change in the magnetic field into an electric signal, and outputs the electric signal from the connector 31 as a signal indicating, e.g., the rotation angle of the inner ring 3 (rotary shaft 100).

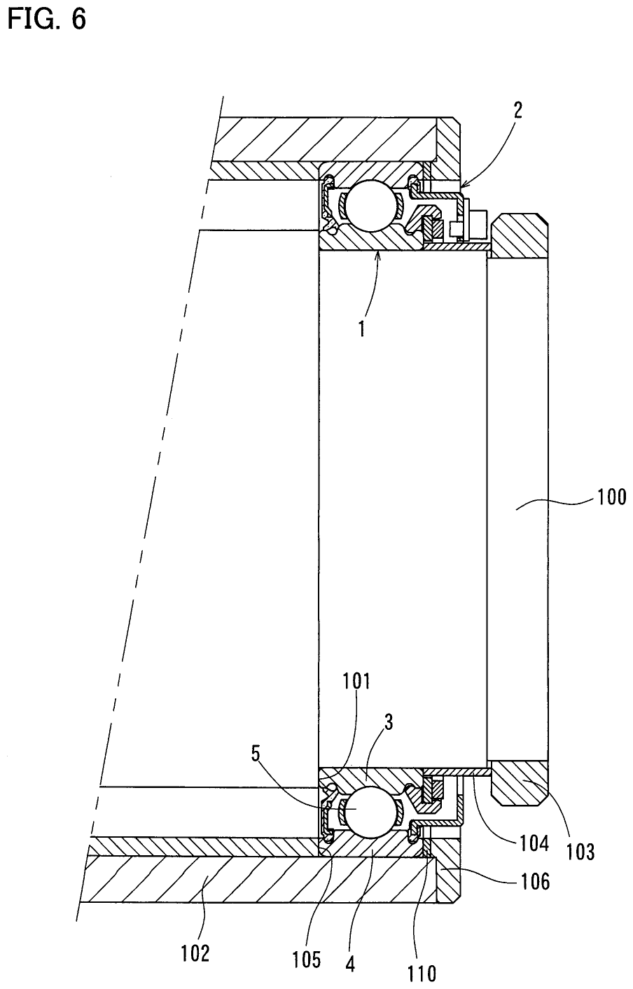

While FIG. 5 exemplifies fixed position preloading, it is also possible to use constant pressure preloading, in which as illustrated in FIG. 6, a spring 110 such as a wave washer is sandwiched between the lid 106 and the inner ring 3, the spring 110 is compressed by fastening the lid 106 to the housing 102, and a preload is applied to the rolling bearing 1.

As described above, the sensor-equipped bearing described of this embodiment illustrated in FIGS. 1 to 3 comprises a rolling bearing 1 including an inner ring 3, an outer ring 4, and a plurality of rolling elements 5; and a magnetic rotation sensor 2 that detects the relative rotational motion between the inner ring 3 and the outer ring 4, wherein the inner ring 3 has a raceway surface 8; a width surface 11 located at one end of the width of the inner ring 3; and an outer peripheral portion 12 that is continuous with the width surface 11 and the raceway surface 8, wherein the magnetic rotation sensor 2 includes a magnetic ring 16 coupled to the outer peripheral portion 12 of the inner ring 3; and a magnetic sensor unit 17 coupled to the outer ring 4, and wherein the magnetic ring 16 comprises a metal core 18 formed into an annular shape; and a magnetic rubber member 19 fixed to the metal core 18.

Especially this sensor-equipped bearing further includes a hook member 20 formed into an annular shape using a resin, and has an outer peripheral groove 12a formed in the outer peripheral portion 12 of the inner ring 3 so as to circumferentially extend, the hook member 20 has a protrusion 25 engaged in the outer peripheral groove 12a of the inner ring 3, and the magnetic ring 16 is held by the hook member 20, so that the protrusion 25 of the hook member 20, which is made of a resin, can be pushed into the outer peripheral groove 12a of the inner ring 3 by using elastic deformation of the hook member 20, and the hook member 20 can be engaged in the outer peripheral groove 12a. As a result, it is not necessary to ensure a large radial interference or a large fitting width between the hook member 20 and the outer peripheral portion 12 of the inner ring 3 unlike a coupling structure relying on press-fitting. Therefore, the hook member 20 can be fixed to the outer peripheral portion 12 of the inner ring 3 while avoiding contraction of the radially inner surface 9 of the inner ring 3, and also the hook member 20 can be fixed to the outer peripheral portion 12 of the inner ring 3 even if the width of the inner ring 3 is small. Since the magnetic ring 16 is held by the hook member 20, the magnetic ring 16 can be coupled to the outer peripheral portion 12 of the inner ring 3 by the hook member 20, and also the position of the magnetic ring 16 can be fixed in position with respect to the inner ring 3. Since the protrusion 25 can be easily taken out of the outer peripheral groove 12a of the inner ring 3 by using elastic deformation of the hook member 20, the hook member 20 and the magnetic ring 16 are not damaged easily when detached from the inner ring 3. Therefore, it is possible to improve reusability of the magnetic ring 16 when the inner ring 3 (rolling bearing 1) is replaced.

As described above, in this sensor-equipped bearing, even when the magnetic ring 16 of the magnetic rotation sensor 2 is coupled to the outer peripheral portion 12 of the inner ring 3 of the rolling bearing 1, contraction of the radially inner surface 9 of the inner ring 3 can be avoided, and even if the width of the inner ring 3 is small, the magnetic ring 16 can be coupled to the outer peripheral portion 12 of the inner ring 3. Also, it is possible to improve the reusability of the magnetic ring 16 when the inner ring 3 is replaced.

Also, in this sensor-equipped bearing, the hook member 20 has a circumferentially extending groove 26, and the metal core 18 is engaged in the groove 26, specifically, by pushing the metal core 18 into the groove 26 of the hook member 20, which is made of a resin, the metal core 18 can be kept engaged in the groove 26, using elastic deformation of the hook member 20. Therefore, it is not necessary to set a tight interference between the groove 26 of the hook member 20 and the metal core 18. Due to this, since it is also possible to easily take the metal core 18 out of the groove 26 by using elastic deformation of the hook member 20, the magnetic ring 16 is not damaged easily when the metal core 18 is detached from the groove 26. As a result, with respect to this sensor-equipped bearing, it is possible to improve reusability of the magnetic ring 16 removed from the hook member 20. Therefore, even if the hook member 20 detached from the inner ring 3 is not suitable for reuse due to damage, deterioration, or the like, it is possible to avoid replacement of the magnetic ring 16.

Also, in this sensor-equipped bearing, the hook member 20 has an inner periphery including the groove 26, the metal core 18 has a first plate surface 21 and a second plate surface 22 axially opposed to each other, the groove 26 is located at a position displaced radially outward from the width surface 11 of the inner ring 3, the first plate surface 21 is axially in contact with the width surface 11 of the inner ring 3, and the groove 26 is hooked on the second plate surface 22. Therefore, the inner peripheral side of the metal core 18 can be axially received by the width surface 11 of the inner ring 3 with the first plate surface 21 kept in contact with the width surface 11, and the outer peripheral side of the metal core 18 can be axially received by the groove 26 with the groove 26 hooked on the second plate surface 22. As a result, even if the area of the groove 26 hooked on the second plate surface 22 is small, the position of the metal core 18 with respect to the hook member 20 and the inner ring 3 can be kept constant, and it is possible to prevent inclination of the metal core 18 with respect to the radial direction. Therefore, in this sensor-equipped bearing, it is possible to reduce the radial depth of the groove 26 so as to reduce the area of the groove 26 hooked on the second plate surface 22. Due to this, it is possible to reduce the outer diameter of the hook member 20, and also to easily remove and insert the metal core 18 with respect to the groove 26.

Also, in this sensor-equipped bearing, since the magnetic rubber member 19 is bonded to the second plate surface 22, the magnetic rubber member 19 can be disposed by using the axial thickness of the portion of the groove 26 of the hook member 20 that is hooked on the second plate surface 22 of the metal core 18 (i.e., by using the width of the inner shoulder portion 27). Therefore, it is possible to reduce the amount by which the magnetic ring 16 axially protrudes with respect to the width surface 11 of the inner ring 3.

Also, in this sensor-equipped bearing, since the metal core 18 comprises a metal plate along the radial direction, i.e., the metal core 18 comprises a plate made of a metal and extending along the radial direction, when manufacturing the metal core 18, it is not necessary to form a flange and perform drawing, thus making it possible to reduce the cost for machining the metal core 18. Also, it is possible to reduce the width and the total radial length of the mental core 18.

Also, in this sensor-equipped bearing, since the magnetic sensor unit 17 includes the magnetic sensor 30 at a position axially opposed to the magnetic rubber member 19, the magnetic sensor 30 and the circuit board 29 can be disposed while avoiding a space located radially outward with respect to the magnetic rubber member 19. Such a disposition is suitable for disposing the magnetic rotation sensor 2 so as not to radially protrude beyond the rolling bearing 1 even if the radial thickness of the rolling bearing 1 between its inner diameter (radially inner surface 9 of the inner ring 3) and its outer diameter (radially outer surface 10 of the outer ring 4) is small.

Also, in this sensor-equipped bearing, since the outer ring 4 has the inner peripheral groove 14, and the magnetic sensor unit 17 is engaged in the inner peripheral groove 14, it is possible to improve reusability of the magnetic sensor unit 17 when replacing the outer ring 4. Also, it is possible to avoid expansion and the like of the radially outer surface 10 of the outer ring 4 even when the magnetic sensor unit 17 is coupled to the inner periphery of the outer ring 4. Also, it is possible to couple the magnetic sensor unit 17 to the inner periphery of the outer ring 4 even if the axial dimension of the outer ring 4 is small.

As described above, this sensor-equipped bearing is economical, because the magnetic ring 16, the hook member 20, and the magnetic sensor unit 17 can be detached from the rolling bearing 1, and reused when the rolling bearing 1 is replaced.

Also, since this sensor-equipped bearing has a structure in which the hook member 20 is engaged in the outer peripheral groove 12a of the inner ring 3, and the sensor holder 28 is engaged in the inner peripheral groove 14 of the outer ring 4, it is possible to use t a standard sealed bearing as the rolling bearing 1. Therefore, it is not necessary to increase the width dimensions of the inner ring 3 and the outer ring 4, and no extra cost is required in bearing manufacturing steps. This is advantageous for reducing the total cost.

Also, since this sensor-equipped bearing has a structure in which the hook member 20 holding the magnetic ring 16 is engaged in the outer peripheral groove 12a of the inner ring 3, and the sensor holder 28 is engaged in the inner peripheral groove 14 of the outer ring 4, the radially inner surface 9 of the inner ring 3 does not contract even if the radial thickness of the bearing 1 between its inner diameter (radially inner surface 9 of the inner ring 3) and its outer diameter (radially outer surface 10 of the outer ring 4) is small, and the radially outer surface 10 of the outer ring 4 does not expand even when the sensor holder 28 is coupled to the inner periphery of the outer ring 4.

In this sensor-equipped bearing, since the radially inner surface 9 of the inner ring 3 does not contract even when the magnetic ring 16 is coupled to the outer peripheral portion 12 of the inner ring 3 by the hook member 20, and the radially outer surface 10 of the outer ring 4 does not expand even when the sensor holder 28 is coupled to the inner periphery of the outer ring 4, it is possible to use the rolling bearing 1 as a rolling bearing dimensionally having standard dimensions.

The present invention is not limited to a rolling bearing having a small radial thickness between the inner diameter and the outer diameter, and can be applied to all rolling bearings.

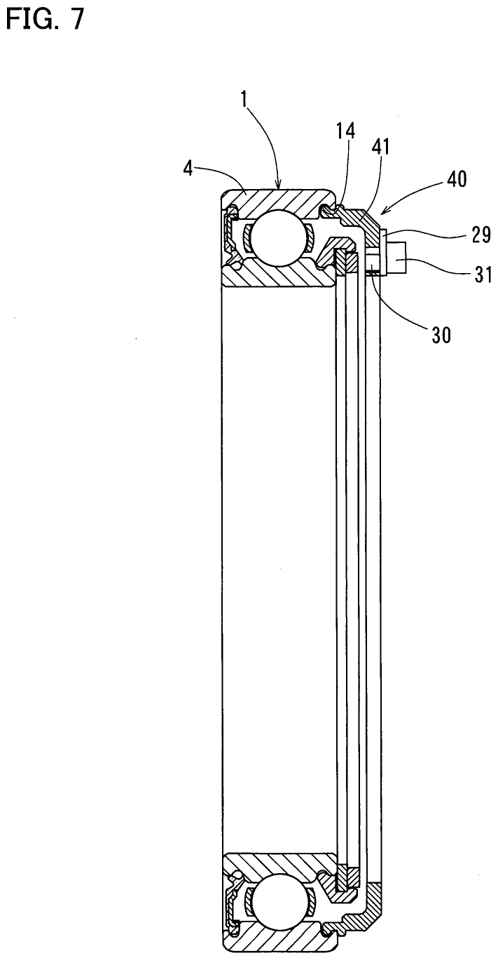

Also, the engagement structure of the sensor holder with respect to the inner peripheral groove of the outer ring is not limited to a structure using elastic deformation of the rubber part, and may be another engagement structure. As an example thereof, a second embodiment is illustrated in FIGS. 7 to 10. Only the features of the second embodiment that are different from those of the first embodiment are described below.

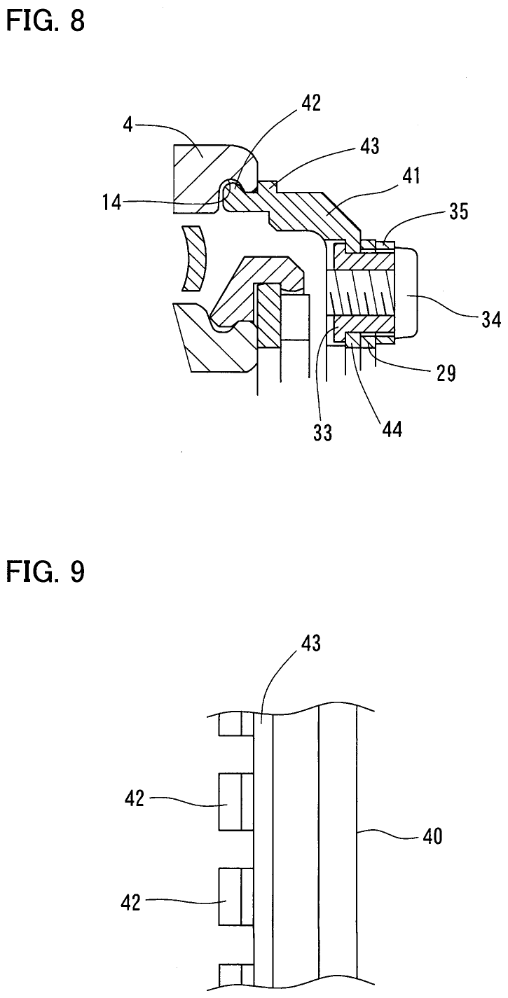

A magnetic sensor unit 40 according to the second embodiment includes a sensor holder 41 made of a resin. The sensor holder 41 is a single seamless tubular member. As illustrated in FIGS. 8 and 9, the sensor holder 41 includes, on its outer periphery, first ribs 42 located at the other end (left end in FIG. 8) of the sensor holder 41; and a second rib 43 located on the side of each rib 42 on which one end thereof is located (on the right side in FIG. 8).

The first ribs 42 are engaged in the inner peripheral groove 14 of the outer ring 4. The first ribs 42 are circumferentially separated from each other so as to be easily pushed into the inner peripheral groove 14. A slit (space) is defined between each circumferentially adjacent pair of first ribs 42. A first rib 42 continuously extending around the entire circumference may be used instead.

The second rib 43 is disposed for restricting axial displacement of the sensor holder 41 toward the side on which one end is located (toward the right side in FIG. 8) by axially bringing the second rib 43 into abutment with the width surface of the outer ring 4 at one end thereof (on the right side in FIG. 8). The second rib 43 continuously extends around the entire circumference.

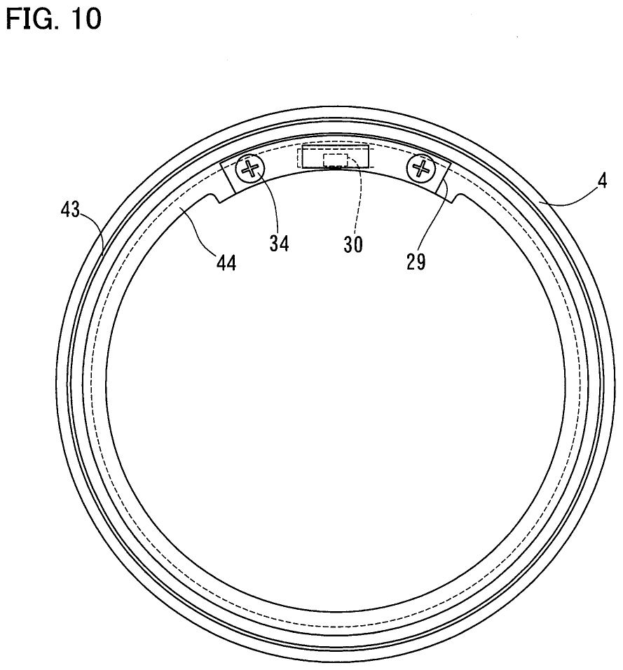

The sensor holder 41 has an inner flange portion 44 having the same shape as that of the first embodiment as illustrated in FIGS. 8 and 10, and has a shape in which the thickness of a required portion such as the inner flange portion 44 is larger than in the first embodiment as illustrated in FIG. 8. Therefore, while the sensor holder is made of a resin, the sensor holder has sufficient strength and rigidity for fastening and supporting the circuit board 29. The periphery of the nut 33 has a counterbore hole shape. In FIG. 10, the inner ring, the hook member, and the magnetic ring are not shown.

The sensor holder 41 can be entirely seamlessly formed by, for example, injection-molding a thermoplastic resin material. As the resin forming the sensor holder 41, a resin material is appropriately selected in accordance with a use environment of the sensor holder 41. For example, if a thermoplastic resin comprising polyphenylene sulfide (PPS) filled with glass fiber, calcium carbonate or the like is used, it is possible to improve stability of the dimensions or the like of the sensor holder 41 with respect to environmental temperature. Also, if the bearing is used under an environment in which temperature generally changes a little like room temperature or the like, for example, polybutylene terephthalate (PBT), polyacetal (POM) or the like can be used.

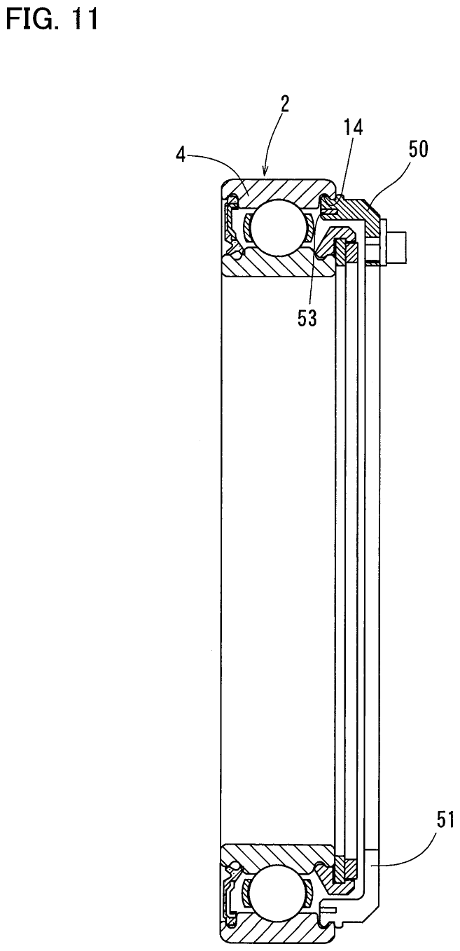

Since a sensor holder continuously extending around the entire circumference is exemplified in each of first and second embodiments, an annular sensor holder having a completed separated portion in a circumferential area thereof and thus having ends may be used instead. FIG. 11 to 13 illustrates a third embodiment as an example thereof. A sensor holder that is further different from the sensor holder of the second embodiment is used in the third embodiment. Only the features of the third embodiment that are different from those of the second embodiment are described below. In FIG. 13, the inner ring, the hook member, and the magnetic ring are not shown.

A sensor holder according to the third embodiment comprises a holder body 50 including a completely separated portion in a circumferential area thereof, and thus having a first circumferential end 51 and a second circumferential end 52 that are circumferentially opposed to each other; and a spring member 53 for biasing the holder body 50 so as to radially expand.

The holder body 50 comprises a single seamless resin portion, and includes a first rib 42 and a second rib 43. A space is defined between the first circumferential end 51 and the second circumferential end 52.

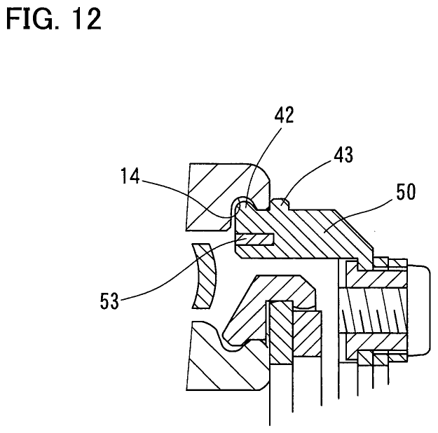

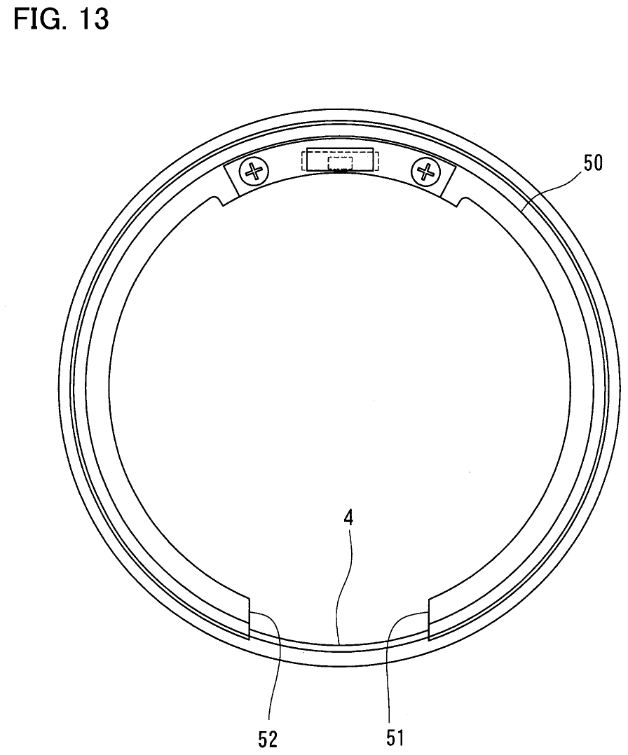

The spring member 53 is an annular member including a completed separated portion in a circumferential area thereof and thus having ends. The spring member 53 comprises a thin metal plate formed into a C shape so as to include a completed separated portion in a circumferential area thereof. The spring member 53 is mounted in a groove that circumferentially extends and has an axial depth from the end surface of the holder body 50 at the other end thereof toward one end thereof (from the left side toward the right side in FIGS. 11 and 12). The spring member 53 extends over the substantially entire circumferential length of the holder body 50.

The first rib 42 is fitted into the inner peripheral groove 14 of the outer ring 4 while elastically deforming the holder body 50 (including the spring member 53) in the direction in which the first circumferential end 51 and the second circumferential end 52 of the holder body 50, to which the spring member 53 is attached, approach each other. After fitting this, when the holder body 50 and the spring member 53 are elastically restored, the first rib 42 is kept engaged in the inner peripheral groove 14, and thereafter, this engaged state is maintained by the elastic restoring force of the spring member 53. As a result, the holder body 50 is fixed to the outer ring 4.

The spring member 53 is not limited to a C-shaped leaf spring, and may be a C-shaped wire spring. Also, instead of the spring member 53, a spring member may be disposed between the first circumferential end and the second circumferential end of the holder body such that the elastic restoring force of the spring member pushes both circumferential ends of the holder body so as to move away from each other, thereby biasing the holder body so as to radially expand.

The sensor-equipped bearing according to each of the above-described embodiments can be applied to, for example, the following Functions a to c, and Applications a to f.
Function a: To detect an absolute angle of rotation based on an absolute output of the magnetic rotation sensor
Function b: To detect a speed and direction of rotation based on an incremental output of the magnetic rotation sensor
Function c: To detect a rotational position of a rotating body such as a motor rotor
Application a: Detection of rotation angle of a joint portion of various robots such as home robots, industrial robots, and AI robots
Application b: Detection of rotation angle of a turning portion of various robots
Application c: Detection of rotation of various motors such as AC servomotors, DC servomotors, and hydraulic motors
Application d: Detection of rotation of various transmissions such as speed reduction devices and speed increasing devices
Application e: Detection of position of various polygon mirrors for reflecting laser light for laser printers, image diagnostic apparatuses, or the like
Application f: Detection of rotation or position of various machines such as industrial machines, construction machines, and spindles

A sensor-equipped bearing including a thin or narrow type rolling bearing is used, for example, in, e.g., various robots and small motors.

The above-described embodiments are mere examples in every respect, and the present invention is not limited thereto. The scope of the present invention is indicated by not the above description but the claims, and should be understood to include all modifications within the meaning and scope equivalent to the scope of the claims.

### DESCRIPTION OF REFERENCE NUMERALS

1: rolling bearing
2: magnetic rotation sensor
3: inner ring
4: outer ring
5: rolling element
8: raceway surface
9: radially inner surface
10: radially outer surface
11: width surface
12: outer peripheral portion
12a: outer peripheral groove
16: magnetic ring
17, 40: magnetic sensor unit
18: metal core
19: magnetic rubber member
20: hook member
21: first plate surface
22: second plate surface
25: protrusion
26: groove
30: magnetic sensor

1. A sensor-equipped bearing comprising:
a rolling bearing including an inner ring, an outer ring, and a plurality of rolling elements; and
a magnetic rotation sensor for detecting a relative rotational motion between the inner ring and the outer ring,
wherein the inner ring has:
a raceway surface;
a width surface located at one end of a width of the inner ring; and
an outer peripheral portion that is continuous with the width surface and the raceway surface,
wherein the magnetic rotation sensor includes:
a magnetic ring coupled to the outer peripheral portion of the inner ring; and
a magnetic sensor unit coupled to the outer ring,
wherein the magnetic ring includes:
a metal core formed into an annular shape; and
a magnetic rubber member fixed to the metal core,
wherein the sensor-equipped bearing further comprises a hook member formed into an annular shape using a resin,
wherein an outer peripheral groove is formed in the outer peripheral portion of the inner ring so as to circumferentially extend,
wherein the hook member has a protrusion engaged in the outer peripheral groove of the inner ring, and
wherein the metal core is held by the hook member.

2. The sensor-equipped bearing according to claim 1, wherein the hook member has a groove that circumferentially extends, and
wherein the metal core is engaged in the groove of the hook member.

3. The sensor-equipped bearing according to claim 2, wherein the hook member has an inner periphery including the groove of the hook member,
wherein the metal core has a first plate surface and a second plate surface axially opposed to each other,
wherein the groove of the hook member is located at a position displaced radially outward from the width surface of the inner ring,
wherein the first plate surface is in contact with the width surface of the inner ring, and
wherein the groove of the hook member is hooked on the second plate surface.

4. The sensor-equipped bearing according to claim 3, wherein the magnetic rubber member is fixed to the second plate surface.

5. The sensor-equipped bearing according to claim 3, wherein the metal core is a metal plate extending along a radial direction.

6. The sensor-equipped bearing according to claim 3, wherein the magnetic sensor unit includes a magnetic sensor at a position axially opposed to the magnetic rubber member.

7. The sensor-equipped bearing according to claim 4, wherein the metal core is a metal plate extending along a radial direction.

8. The sensor-equipped bearing according to claim 4, wherein the magnetic sensor unit includes a magnetic sensor at a position axially opposed to the magnetic rubber member.

9. The sensor-equipped bearing according to claim 5, wherein the magnetic sensor unit includes a magnetic sensor at a position axially opposed to the magnetic rubber member.
